(19) United States
(12) Patent Application Publication
(10) Pub. No.: US 2015/0351443 A1
(43) Pub. Date: Dec. 10, 2015

(54) HYDRATING COMPOSITIONS

(71) Applicant: ABBOTT LABORATORIES, Abbott Park, IL (US)

(72) Inventors: DEBORAH STROZIER, Westerville, OH (US); STEVEN HERTZLER, Worthington, OH (US); JEFFREY SALYERS, Columbus, OH (US)

(73) Assignee: ABBOTT LABORATORIES, Abbott Park, IL (US)

(21) Appl. No.: 14/731,631

(22) Filed: Jun. 5, 2015

Related U.S. Application Data
(60) Provisional application No. 62/008,889, filed on Jun. 6, 2014.

(51) Int. Cl. A23L 2/39; A23L 1/304; A23L 2/68; A23L 2/38; A23L 2/56

(52) U.S. Cl. CPC A23L 2/39; A23L 2/38; A23L 2/56; A23L 2/68; A23L 1/304; A23V 2002/00

(57) ABSTRACT

Powdered and liquid hydrating compositions and methods for hydrating an adult subject are provided. The compositions may include a combination of carbohydrates, sodium, potassium, chloride, citric acid, and malic acid. The powdered compositions include an anti-caking agent.

### CROSS-REFERENCE TO RELATED APPLICATIONS

This application claims the benefit of U.S. Provisional Application No. 62/008,889, filed Jun. 6, 2014, the entire content of which is incorporated by reference herein.

### TECHNICAL FIELD

The present disclosure is directed to a composition for hydrating an adult subject, and the use of the composition for rehydration of the subject. The composition may also be used to aid in the replacement of electrolytes lost by an adult subject, such as during exercise.

### BACKGROUND

Dehydration may occur due to physical activity, injury, or illness, and often occurs when a subject fails to adequately replace fluids lost through sweating, fever, diarrhea, vomiting, hyponatremia, or changes in altitude. Hydration requirements vary among individuals. For example, advanced age may render one more prone to dehydration.

Sports beverages are a common product targeted at rehydrating a subject. These products, however, are often formulated for consumption right before, during, or right after exercise or other similar activity. Such sports beverages may be inadequate to properly rehydrate subjects due to a number of factors including improper electrolyte or sodium content and unnecessary or counterproductive ingredients.

### SUMMARY

It has been found that the embodiments of the inventive compositions for hydrating an adult subject, according to the present disclosure, have improved absorption and electrolyte replenishment for better hydration, and also have improved palatability for adults.

In one embodiment, a powdered composition for hydrating a subject is provided. The powdered composition comprises, per serving, 50-80 wt. % carbohydrates; 2.8-4.0 wt. % sodium; 2.1-2.7 wt. % potassium; 3.4-5.0 wt. % chloride; 5.0-7.8 wt. % citric acid; 4.4-6.8 wt. % malic acid; and 0.49-1.2 wt. % of an anti-caking agent.

In one embodiment, a method of hydrating an adult subject is provided. The method comprises dissolving a powdered composition comprising 50-80 wt. % carbohydrates; 2.8-4.0 wt. % sodium; 2.1-2.7 wt. % potassium; 3.4-5.0 wt. % chloride; 5.0-7.8 wt. % citric acid; 4.4-6.8 wt. % malic acid; and 0.49-1.2 wt. % of an anti-caking agent in a liquid to form an oral hydration composition, and administering the oral hydration composition to the subject.

In one embodiment, a liquid composition for hydrating an adult subject is provided. The liquid composition comprises, per ounce of solution: 0.55 wt. % carbohydrates; 0.0125 wt. % sodium; 0.00875 wt. % potassium; 0.0175 wt. % chloride; 0.025 wt. % citric acid; and 0.0225 wt. % malic acid.

### DETAILED DESCRIPTION

Embodiments of the present disclosure provide compositions for hydrating a subject. The embodiments comprise a combination of carbohydrates, sodium, potassium, chloride, citric acid, and malic acid. The embodiments may be in powdered or liquid form. The powdered compositions typically comprise an anti-caking agent. The disclosed embodiments have improved absorption and electrolyte replenishment to aid in hydrating an adult subject, while providing a taste profile that encourages consumption thereof. For example, embodiments of the present disclosure may increase fluid retention by 30% as compared to consumption of only water.

The term “hydrating composition” as used herein, unless otherwise specified, refers to products in various forms including, but not limited to, liquids, solids, powders, semi-solids, semi-liquids, supplements, and any other food product intended to replace fluids lost through biological functions such as digestion, perspiration, etc., or by other means, which are used to replace fluids and electrolytes, such as sodium, lost in order to prevent or manage dehydration. In some embodiments, a hydrating composition in powder form can be reconstituted to form a hydrating composition in liquid form. The embodiments of hydrating compositions disclosed herein are generally suitable for oral consumption by a human.

The terms “hydrating powder” and “reconstitutable powder” as used herein, unless otherwise specified, are used interchangeably to refer to compositions in flowable or scoopable form that can be reconstituted with water or other aqueous liquids prior to consumption for the replacement of fluids lost through biological functions such as digestion, perspiration, etc., or by other means. These terms include both spray dried and drymixed/dryblended powders.

The term “hydrating liquid” as used herein, unless otherwise specified, refers to hydrating compositions in ready-to-drink liquid form, concentrated liquid form, and hydrating liquids made by reconstituting hydrating powders described herein prior to use for the replacement of fluids lost through biological functions such as digestion, perspiration (sweating), etc., or by other means. Although typically a solution, the hydrating liquid may also be formulated as a suspension, an emulsion, and so forth.

The terms “administer,” “administering,” “administered,” and “administration” as used herein, unless otherwise specified, should be understood to include providing a composition to an individual, the act of consuming a composition, and combinations thereof.

The term “serving” as used herein, unless otherwise specified, is intended to be construed as any amount which is intended to be consumed by an individual in one sitting or within one hour or less. The hydrating compositions according to certain embodiments of this disclosure include those suitable for oral administration. Oral administration, as defined herein, includes any form of administration in which the composition passes through the esophagus of the individual.

The embodiments of hydrating compositions disclosed herein for hydrating a subject exhibit improved absorption for better hydration and replenishment of the electrolytes lost due to, for example, dehydration, sweating, fever, diarrhea, vomiting, hyponatremia, or changes in altitude. The sodium content of the compositions promotes retention of fluids and maintenance of electrolyte balance which acts to prevent further dehydration. The hydrating compositions disclosed herein sufficiently replace the amount of fluid lost and provide adequate amounts of electrolytes to replenish those lost due to exercise, dehydration, or any of the above-noted ailments and/or illnesses.

In certain embodiments, the hydration compositions are in the form of a reconstitutable powder. The hydration powders may be reconstituted with any liquid, such as water or juice, prior to use, and may comprise the embodied compositions disclosed herein. In certain embodiments, the hydration powders are reconstituted in 8 ounces of liquid.

In one embodiment, the hydrating composition is a powdered composition for hydrating a subject. The hydrating composition may be particularly effective when the subject is an elderly subject, an exercising adult subject, an adult subject after exercise (i.e., an adult subject who has been physically active within the preceding 4-6 hours), or an adult subject suffering from an injury or illness, or from dehydration, sweating, fever, diarrhea, vomiting, hyponatremia, or experiencing changes in altitude. Dehydration occurs when an excessive loss of body water exceeds water intake in a subject. In athletes, dehydration may be measured by the specific gravity of their urine. A specific gravity of greater than or equal to 1.02 signifies dehydration; a specific gravity of less than 1.02 signifies adequate hydration. The powdered composition comprises, per serving, 50-80 wt. % carbohydrates; 2.8-4.0 wt. % sodium; 2.1-2.7 wt. % potassium; 3.4-5.0 wt. % chloride; 5.0-7.8 wt. % citric acid; 4.4-6.8 wt. % malic acid; and 0.49-1.2 wt. % of an anti-caking agent. As used herein, the term “adult subject” refers to a human having an age of 18 years to 50 years. The term “elderly subject” as used herein refers to a human having an age of greater than 50 years.

The anti-caking agent operates to maintain the flowability (e.g., prevent clumping) of the powdered composition over time, which provides the powdered composition with a relatively long shelf-life over which the powdered composition can be effectively used. For example, the powdered composition can have an effective shelf-life of 24 months if stored in packaging that restricts oxygen and moisture migration into the powdered composition.

In one embodiment, the powdered composition comprises 250-270 mg of sodium per 8.5 gram serving. In one embodiment, the powdered composition comprises 270 mg of sodium per 8.5 gram serving. In another embodiment, the powdered composition comprises 340 mg of chloride per 8.5 gram serving. In another embodiment, the powdered composition comprises 180 mg of potassium per 8.5 gram serving. In another embodiment, the powdered composition comprises 11% of the recommended daily value of sodium for an adult subject. In another embodiment, the powdered composition comprises 8-10% of the recommended daily value of chloride for an adult subject. In another embodiment, the powdered composition comprises 10% of the recommended daily value of chloride for an adult subject. In another embodiment still, the powdered composition comprises 5% of the recommended daily value of potassium for an adult subject.

In certain embodiments, the powdered composition has a bulk density of 0.8 to 1.1 g/cc.

Certain embodiments of the powdered compositions comprise a concentration of citric acid that is less than 7.8 wt % per serving. Certain embodiments of the powdered compositions comprise a concentration of citric acid that is from 6.3-6.9 wt % per serving. Certain embodiments of the powdered compositions comprise a concentration of citric acid that is from 5.5-6.2 wt % per serving.

Certain embodiments of the powdered compositions comprise a concentration of malic acid that is less than 6.8 wt % per serving. Certain embodiments of the powdered compositions comprise a concentration of malic acid that is from 5.4-6.1 wt % per serving. Certain embodiments of the powdered compositions comprise a concentration of malic acid that is from 4.9-5.3 wt % per serving.

Certain embodiments of the powdered compositions comprise a concentration of the anti-caking agent that is greater than 0.5 wt % per serving. Non-limiting examples of suitable anti-caking agents include calcium silicate, silicone dioxide, aluminum calcium silicate, magnesium silicate, tricalcium silicate, sodium aluminosilicate, sodium calcium aluminosilicate, aluminum stearate, calcium stearate, magnesium stearate, zinc stearate, calcium phosphate, magnesium phosphate, magnesium carbonate, zinc oxide, and starch. Certain embodiments of the powdered compositions comprise food-grade anticaking agents.

In certain embodiments, the carbohydrates of the powdered composition comprise dextrose, maltodextrin, sucrose, or combinations thereof. In certain embodiments, the maltodextrin has a dextrose equivalent (DE) value of less than or equal to 20. In certain embodiments, the maltodextrin has a DE of 1-10.

In certain embodiments of the powdered compositions, the ratio of citric acid to malic acid is from 0.73:1.0 to 1.77:1.0. In certain embodiments of the powdered compositions, the ratio of malic acid to citric acid is from 0.56:1.0 to 1.36:1.0. In certain embodiments of the powdered compositions, the ratio of citric acid to anti-caking agent is from 4.17:1.0 to 15.92:1.0. In certain embodiments of the powdered compositions, the ratio of malic acid to anti-caking agent is from 3.66:1.0 to 13.89:1.0.

Certain embodiments of the powdered compositions comprise one or more flavoring agents which change or enhance the flavor of the powdered compositions and which may improve the hedonic or mouthfeel characteristics of the powdered compositions. In certain embodiments, the one or more flavoring agents is selected from the group consisting of a strawberry flavoring agent, a cherry flavoring agent, an orange flavoring agent, a pineapple flavoring agent, a grape flavoring agent, an apple flavoring agent, a lime flavoring agent, and combinations thereof. In certain embodiments, the powdered compositions are fruit punch flavored and include a strawberry flavoring agent, a cherry flavoring agent, an orange flavoring agent, and a pineapple flavoring agent. One embodiment of the fruit punch flavored powdered composition includes 1.56 wt. % strawberry flavoring agent, 0.69 wt. % cherry flavoring agent, 0.0907 wt. % orange flavoring agent, and 0.0453 wt. % pineapple flavoring agent per serving. Certain embodiments of the powdered compositions include only an orange flavoring agent. In one embodiment, the powdered composition includes 6.27 wt. % orange flavoring agent per serving.

The various embodiments of the hydrating compositions disclosed herein, as well as other contemplated embodiments, may be prepared by any process or suitable method (now known or known in the future) for making a selected product form. Many such techniques are known for any given product form and can easily be applied by one of ordinary skill in the art to the various embodiments presented herein. Examples include dry blending the powder using a ribbon blender or v-blender.

In certain embodiments, the powdered compositions are in the form of flowable or substantially flowable particulate compositions, or at least particulate compositions that may be easily scooped and measured with a spoon or similar device, wherein the compositions may be reconstituted with a suitable aqueous fluid, such as water, to form a liquid hydrating composition for oral use. The embodiments include spray dried, agglomerated, dry blended or other known or otherwise effective particulate forms. The quantity of hydrating powder required to produce a volume suitable for one serving may vary. In certain embodiments of the powdered compositions, a serving may range from 7.5 to 8.5 grams of the powdered composition. In certain embodiments of the powdered composition, the serving provides adequate replacement of the amount of fluids lost and adequate replenishment of electrolytes lost in order to rehydrate a subject experiencing or at risk of dehydration.

In another embodiment, a method of hydrating a subject (e.g., a subject experiencing or at risk of dehydration) is provided. The method comprises preparing an oral hydration composition by dissolving a powdered hydrating composition in a liquid, the powdered hydrating composition comprising any of the embodiments described or otherwise suggested herein, and administering the oral hydration composition to the subject, for example, any of the subjects described or otherwise suggested herein. The liquid may be water or any other liquid (e.g., a juice) suitable for dissolving the powdered composition.

In certain embodiments, liquid compositions for hydrating a subject are provided. In one embodiment, a serving of the liquid composition is 8 fluid ounces and comprises, in weight percent: 2.40% carbohydrates; 0.10% sodium; 0.07% potassium; 0.14% chloride; 0.20% citric acid; and 0.18% malic acid. In one embodiment, the liquid composition further comprises 2.0% dextrose.

### Examples

The following examples further describe and demonstrate embodiments within the scope of the present disclosure. The examples are given solely for the purpose of illustration and are not to be construed as limitations of the present disclosure, as many variations thereof are possible without departing from the spirit and scope of the disclosure. All ingredient amounts listed as weight percentages are based upon the total weight of the composition, unless otherwise specified. Ingredients may also be listed on a gram per serving basis.

Example 1 illustrates one embodiment of a hydrating composition in the form of a hydrating powder. The hydrating composition shown in Table 1 is a fruit punch flavored hydrating powder formulated for reconstitution into a liquid at a rate of approximately 7.5 g of powder per 8 ounces of liquid.

TABLE 1

| Ingredient | Weight Percent | Gram Serving |
|---|---|---|
| Dextrose Anhydrous | 64.6407 | 4.84805 |
| Tripotassium Citrate | 7.5593 | 0.56695 |
| Salt | 7.9867 | 0.59900 |
| Citric Acid | 6.6300 | 0.49725 |
| Malic Acid | 5.7800 | 0.43350 |
| Sodium Citrate-Anhydrous | 3.3207 | 0.24905 |
| Natural and Artificial | 1.5640 | 0.11730 |
| Strawberry Flavor | | |
| Calcium Silicate | 1.0000 | 0.07500 |
| Natural and Artificial Cherry | 0.6913 | 0.05185 |
| Flavor | | |
| Sucralose | 0.3287 | 0.02465 |
| Acesulfame Potassium | 0.2720 | 0.02040 |
| Natural and Artificial Orange | 0.0907 | 0.00680 |
| Flavor | | |
| FD&C Red 40 | 0.0907 | 0.00680 |
| Artificial Pineapple Flavor | 0.0453 | 0.00340 |

Example 2 illustrates one embodiment of a hydrating composition in the form of a hydrating powder. The hydrating composition shown in Table 2 is an orange flavored hydrating powder formulated for reconstitution into a liquid at a rate of approximately 7.5 g of powder per 8 ounces of liquid.

TABLE 2

| Ingredient | Weight Percent | Gram Serving |
|---|---|---|
| Dextrose, Anhydrous | 60.7647 | 4.55735 |
| Salt | 7.9867 | 0.59900 |
| Tripotassium Citrate | 7.5593 | 0.56695 |
| Citric Acid | 6.6300 | 0.49725 |
| Natural and Artificial Orange | 6.2673 | 0.47005 |
| Flavor | | |
| Malic acid | 5.7800 | 0.43350 |
| Sodium Citrate | 3.3207 | 0.24905 |
| Calcium Silicate | 1.0000 | 0.07500 |
| Sucralose | 0.3287 | 0.02465 |
| Acesulfame Potassium | 0.2720 | 0.02040 |
| FD&C Yellow 6 | 0.0907 | 0.00680 |

Example 3 illustrates one embodiment of a hydrating composition in the form of a hydrating powder. The hydrating composition shown in Table 3 is an orange flavored hydrating powder formulated for reconstitution into a liquid at a rate of approximately 8.5 g of powder per 8 ounces of liquid.

TABLE 3

| Ingredient | Weight Percent | Gram Serving |
|---|---|---|
| Dextrose, Anhydrous | 65.8100 | 5.59385 |
| Salt | 6.5000 | 0.55250 |
| Tripotassium Citrate | 6.6700 | 0.56695 |
| Citric Acid | 5.8500 | 0.49725 |
| Natural and Artificial Orange | 5.5300 | 0.47005 |
| Flavor | | |
| Malic acid | 5.1000 | 0.43350 |
| Sodium Citrate | 2.9300 | 0.24905 |
| Calcium Silicate | 1.0000 | 0.08500 |
| Sucralose | 0.2900 | 0.02465 |
| Acesulfame Potassium | 0.2400 | 0.02040 |
| FD&C Yellow 6 | 0.0800 | 0.00680 |

The hydrating compositions provided herein as reconstitutable powders have benefits, such as longer shelf life, over ready-to-feed liquids. Sensory testing showed minimal changes to sensory performance of the embodiments of powdered hydrating compositions herein over five-month and six-month periods.

Example 4 illustrates one embodiment of a hydrating composition in the form of a hydrating liquid. Table 4 shows the comparison of certain minerals found in the liquid hydrating composition with those minerals as found in the reconstituted powdered hydrating composition and as typically found in the composition of human sweat.

TABLE 4

| In 8 oz | | | |
|---|---|---|---|
| solution | Liquid | Reconstituted | Sweat Content |
| (weight | Hydrating | Powdered Hydrating | of the General |
| percent) | Composition | Composition | Population |
| Sodium | 0.10% | 0.045%-0.18% | 0.045%-0.184% |
| Carbohydrate | 2.40% | 2-4% | — |
| Dextrose | 2.00% | 2-4% | — |
| Potassium | 0.07% | 0.02-12% | 0.0158%-0.0317% |
| Chloride | 0.14% | 0.12%-0.46% | 0.07%-0.212% |
| Citric Acid | 0.20% | 0.20% | — |
| Malic Acid | 0.18% | 0.10-0.18% | — |

Example 5 illustrates one embodiment of a hydrating composition in the form of a hydrating powder. Table 5 shows the comparison of certain minerals found in the powdered hydrating composition with those minerals as found in the composition of 8 ounces of human sweat. The hydrating composition in Table 5 is an 8.5 gram serving of powdered composition reconstituted with 8 ounces of water.

TABLE 5

| | Hydrating Composition | Sweat |
|---|---|---|
| mg Sodium | 270 | 110-442 |
| mg Chloride | 340 | 170-511 |

Example 6 includes the results of a study that compares rehydration using water to a hydrating composition, such as those disclosed herein, following exercise-induced dehydration in team sports athletes. Twenty-six male subjects, consisting mainly of intercollegiate athletes who had an oxygen uptake of at least 50 mL/kg/min, underwent intermittent, high-intensity exercise for 81 minutes resulting in dehydration as shown by a 2-3% decrease in body mass. Subjects consumed a standardized diet and refrained from exercise for the 24-hour period prior to each eight-hour experiment.

The exercise consisted of three periods of a two-minute warm-up followed by 25 minutes of intermittent-intensity exercise on a treadmill, stationary bike, and elliptical machine in varied order. A five-minute break was provided between periods for subjects to have their body weight checked, to stretch, and to dry off as needed. No fluids were ingested during exercising. A sweat sample was collected from each subject and analyzed for sodium concentration. The sodium concentration was used to estimate whole body sodium loss during exercise. The volume of fluid ingested multiplied by the known sodium content of the beverage established sodium intake. The difference between sodium lost and sodium ingested is the final sodium balance.

Table 6 illustrates some results from the afore-mentioned study. The subjects, which were dehydrated equally for each study (% Dehydration), ingested roughly 100% of the volume of fluid lost in either water or hydrating composition following exercise to replace the lost fluid and restore lost body mass. Table 6 shows the mean with standard deviation for the percentages of fluid retained, body mass restored, initial body mass, and dehydration. The percentage of fluid retained within body cells was measured by noting the volume of fluid lost through urination at 30, 60, 135, and 210 minutes following ingestion of either water or hydrating composition. As illustrated below, subjects on average retained more fluids after ingesting the hydrating composition following dehydration than they did after ingesting water alone. Decreased urination is indicative of more effective rehydration. As discussed above, the hydrating compositions disclosed herein exhibit improved absorption for better hydration and replenishment of the electrolytes lost following dehydration. The sodium content of the hydrating compositions promotes retention of fluids and maintenance of electrolyte balance by providing adequate amounts of electrolytes to replenish those lost during exercising. Table 7, which shows the percentage of fluid retained for individual subjects, further illustrates the noted positive correlation between the sodium balance in an individual, promoted by the sodium content of the ingested hydrating composition (as compared to water which contains no sodium), and the percentage of fluid an individual retains after consuming rehydrating fluids following dehydration.

TABLE 6

| | | % Body | | |
|---|---|---|---|---|
| Fluid | % Fluid | Mass | Initial | % De- |
| Ingested | retained* | Restored* | body mass | hydration |
| Water | 58.1 ± 12.6^{a} | 98.0 ± 0.9^{a} | 74.5 ± 10.0 | 2.57 ± 0.50 |
| Reconstituted | 76.9 ± 8.0^{b} | 98.7 ± 0.3^{b} | 74.6 ± 10.1 | 2.57 ± 0.56 |
| Hydrating | | | | |
| Composition | | | | |

*ANOVA indicates statistical difference exists between treatments. Different subscripts indicate statistically significant differences using Tukey's HSD (required difference: 7.125 for p < 0.05)

TABLE 7

| | | Reconstituted Hydrating |
|---|---|---|
| Subject | Water | Composition |
| 1 | 50.47226 | 70.65748 |
| 2 | 58.33576 | 85.0827 |
| 3 | 42.70503 | 85.11745 |
| 4 | 62.9089 | 66.96854 |
| 5 | 65.6664 | 76.42079 |
| 6 | 52.76944 | 83.75068 |
| 7 | 60.75303 | 84.18874 |
| 8 | 46.31891 | 65.01386 |
| 9 | 62.1090 | 72.8666 |
| 10 | 48.00513 | 76.31005 |
| 11 | 64.84281 | 77.30013 |
| 12 | 50.29575 | 87.17079 |
| 13 | 39.51093 | 68.01444 |
| 14 | 66.41439 | 83.45706 |
| 15 | 63.19551 | 74.71256 |
| 16 | 71.8824 | 89.88116 |
| 17 | 70.15187 | 65.19177 |
| 18 | 67.62997 | 78.47639 |
| 19 | 84.24592 | 85.76276 |
| 20 | 49.36474 | 77.89033 |
| 21 | 80.45982 | 88.0977 |
| 22 | 39.19188 | 73.66133 |
| 23 | 38.10606 | 69.42902 |
| 24 | 43.35763 | 80.70603 |
| 25 | 66.29105 | 69.95274 |
| 26 | 65.34518 | 62.31255 |
| mean | 58.08961 | 76.86129 |
| sd | 12.64113 | 8.043525 |

All percentages, parts, and ratios as used herein are by weight of the total composition, unless otherwise specified. All such weights as they pertain to listed ingredients are based on the active level and, therefore, do not include solvents or by-products that may be included in commercially available materials, unless otherwise specified.

All combinations of method or process steps as used herein may be performed in any order, unless otherwise specified or clearly implied to the contrary by the context in which the referenced combination is made.

While the present disclosure has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the disclosure, in its broader aspects, is not limited to the specific details, the representative apparatus, and illustrative examples shown and described. Accordingly, departures may be made from such details without departing from the spirit or scope of the applicant's general inventive concept.

What is claimed is:

1. A powdered composition for hydrating a subject, the composition comprising per serving: 50 to 80 wt. % carbohydrates; 2.8 to 4.0 wt. % sodium; 2.1 to 2.7 wt. % potassium; 3.4 to 5.0 wt. % chloride; 5.0 to 7.8 wt. % citric acid; 4.4 to 6.8 wt. % malic acid; and 0.49 to 1.2 wt. % of an anti-caking agent.

2. The powdered composition of claim 1, wherein a serving comprises 7.5 to 8.5 grams of powdered composition.

3. The powdered composition of claim 1, wherein a concentration of the citric acid is 6.3 to 6.9 wt %.

4. The powdered composition of claim 1, wherein a concentration of the malic acid is 5.4 to 6.1 wt %.

5. The powdered composition of claim 1, wherein the anti-caking agent is selected from the group consisting of calcium silicate, silicone dioxide, aluminum calcium silicate, magnesium silicate, tricalcium silicate, sodium aluminosilicate, sodium calcium aluminosilicate, aluminum stearate, calcium stearate, magnesium stearate, zinc stearate, calcium phosphate, magnesium phosphate, magnesium carbonate, zinc oxide, starch, and combinations thereof.

6. The powdered composition of claim 1, wherein the carbohydrates are selected from the group consisting of dextrose, maltodextrin, sucrose, and combinations thereof.

7. The powdered composition of claim 6, wherein the maltodextrin has a dextrose equivalent value of less than or equal to 20.

8. The powdered composition of claim 1, wherein a ratio of the citric acid to the malic acid is from 0.73:1.0 to 1.77:1.0.

9. The powdered composition of claim 1, wherein a ratio of the citric acid to the anti-caking agent is from 4.17:1.0 to 15.92:1.0.

10. The powdered composition of claim 1, wherein a ratio of the malic acid to the anti-caking agent is from 3.66:1.0 to 13.89:1.0.

11. The powdered composition of claim 1, further comprising one or more flavoring agents selected from the group consisting of a strawberry flavoring agent, a cherry flavoring agent, an orange flavoring agent, a pineapple flavoring agent, a grape flavoring agent, an apple flavoring agent, and a lime flavoring agent.

12. The powdered composition of claim 1, wherein the powdered composition has a bulk density of 0.8 to 1.1 g/cc.

13. A method of hydrating a subject, the method comprising:
dissolving a powdered composition in a liquid to form a serving of an oral hydration composition, the powdered composition comprising, per the serving of the oral hydration composition:
50 to 80 wt. % carbohydrates;
2.8 to 4.0 wt. % sodium;
2.1 to 2.7 wt. % potassium;
3.4 to 5.0 wt. % chloride;
5.0 to 7.8 wt. % citric acid;
4.4 to 6.8 wt. % malic acid; and
0.49 to 1.2 wt. % of an anti-caking agent; and
administering the oral hydration composition to the subject.

14. The method of claim 13, wherein the subject is one of suffering from dehydration and at risk of dehydration.

15. The method of claim 14, wherein the subject comprises one of an elderly subject, an exercising adult subject, an adult subject after exercise, or an adult subject suffering from at least one of an injury or an illness.

16. The method of claim 15, wherein the adult subject after exercise consumes the oral hydration composition within one hour or less after exercising.

17. The method of claim 13, wherein the serving of the oral hydration composition comprises 7.5-8.5 grams of the powdered composition.

18. The method of claim 13, wherein the powdered composition is dissolved in at least 8 fluid ounces of liquid.

19. The method of claim 18, wherein the liquid is water.

20. A liquid composition for hydrating a subject, wherein a serving is 8 fluid ounces of solution, and wherein the serving comprises: 2.40 wt. % carbohydrates; 0.10 wt. % sodium; 0.07 wt. % potassium; 0.14 wt. % chloride; 0.20 wt. % citric acid; and 0.18 wt. % malic acid.

21. The liquid composition of claim 20 further comprising 2.0% dextrose.

22. The liquid composition of claim 20, wherein the remaining wt. % of the liquid composition is water.
